(19) United States
(12) Patent Application Publication
(10) Pub. No.: US 2016/0380475 A1
(43) Pub. Date: Dec. 29, 2016

(54) NETWORK DEVICE WITH INTELLIGENT POWER CONFIGURATION FUNCTION

(71) Applicant: EtherWAN Systems, Inc., New Taipei City (TW)

(72) Inventor: Ming-Chau Yang, New Taipei City (TW)

(21) Appl. No.: 15/194,691

(22) Filed: Jun. 28, 2016

(30) Foreign Application Priority Data
Jun. 29, 2015 (CN) 201510366851.2

(51) Int. Cl. H02J 9/06; H02J 7/00

(52) U.S. Cl. CPC H02J 9/06; H02J 7/0068

(57) ABSTRACT

A network device with an intelligent power configuration function includes one or more power input ports, one or more output ports, a detection module, and a control module. The power input port is for receiving external power. The output port is for being connected to an external network device, and the output port provides the external power received by the power input port to the external network device. The detection module is for generating an abnormal signal when detecting that the external power received by the power input port is provided by a battery module of a UPS. The control module is for closing, according to a power-off sequence corresponding to each output port, power output of the output port when receiving the abnormal signal, so as to stop the output port supplying power to the external network device.

### CROSS-REFERENCES TO RELATED APPLICATIONS

This non-provisional application claims priority under 35 U.S.C. §119(a) on Patent Application No. 201510366851.2 filed in China, P.R.C. on 2015 Jun. 29, the entire contents of which are hereby incorporated by reference.

### BACKGROUND

Technical Field

The present invention relates to a network device, and in particular, to a network device with an intelligent power configuration function that is capable of selecting, according to a power source, a corresponding operation.

Related Art

In the field of network communications, a head-end network device (network device for short below), such as a router, a switch, or an optical-to-electrical converter, is usually configured to be connected to more than one external network device, such as a computer and a network camera, and configured to perform multi-party data transmission with the external network devices. However, the network device and the external network devices need to receive external power, e.g. be connected to mains, so as to work normally. Therefore, each of the network device and the external network devices needs to be configured with a power line for receiving the mains, and a network line for transmitting data. In addition, a position for installing each of the network device and the external network devices is readily limited to a position of a mains socket, thereby causing problems such as being huge in size and being difficult in construction.

To eliminate the foregoing deficiencies, those skilled in the art attach a requirement of power transmission to arrangement of existing network lines, so as to save configuration of a large number of power lines. Therefore, an existing network device may not only perform, by using network lines, multi-party data transmission with external network devices connected to the network device, but also deliver, by using the network lines, mains received by the network device to the external network devices. Besides, an operation of an uninterruptible power supply (uninterruptible power supply, UPS) may be used in combination. Therefore, even a failure, such as trip-out or power-off, occurs in the mains provided by a mains network, the UPS may be used instead to provide external power, so as to keep a normal operation of the network device.

It is commonly known that power supply of a UPS is provided by power pre-stored in a battery module of the UPS, and therefore, the total power that the UPS can provide is limited. Therefore, when a network device is connected to multiple external network devices, a power supply time of the UPS is substantially reduced. If the power pre-stored in the UPS is completely consumed before the mains power supply is restored, the multiple external network devices are suddenly powered off. Besides, if the external network devices are powered off when important data thereof is not saved yet, a serious and irreparable damage to the data may be further caused.

### SUMMARY

In view of the above, an embodiment of the present invention provides a network device with an intelligent power configuration function, including: at least one power input port, at least one output port, a detection module, and a control module. The at least one power input port is configured to receive external power. The at least one output port is separately configured to be connected to an external network device, and provide the external power received by the at least one power input port to the connected external network device. The detection module is configured to generate an abnormal signal when detecting that the external power received by the at least one power input port is provided by a battery module of a UPS, and output the abnormal signal. The control module is configured to close, according to a power-off sequence corresponding to each output port, power output of the at least one output port when receiving the abnormal signal, so as to stop supplying power to the external network device.

To sum up, with the network device with an intelligent power configuration function according to an embodiment of the present invention, when it is detected that received external power is provided by a battery module of a UPS, power supply of an external network device with a relatively low importance hierarchy is stopped first according to a power-off sequence of each output port, so as to prolong operation times of remaining external network devices with relatively high importance hierarchies.

Features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a network device with an intelligent power configuration function according to an embodiment of the present invention; and

FIG. 2 is a general schematic diagram of another connection aspect between the network device according to FIG. 1, a UPS, and an external power supply end.

### DETAILED DESCRIPTION

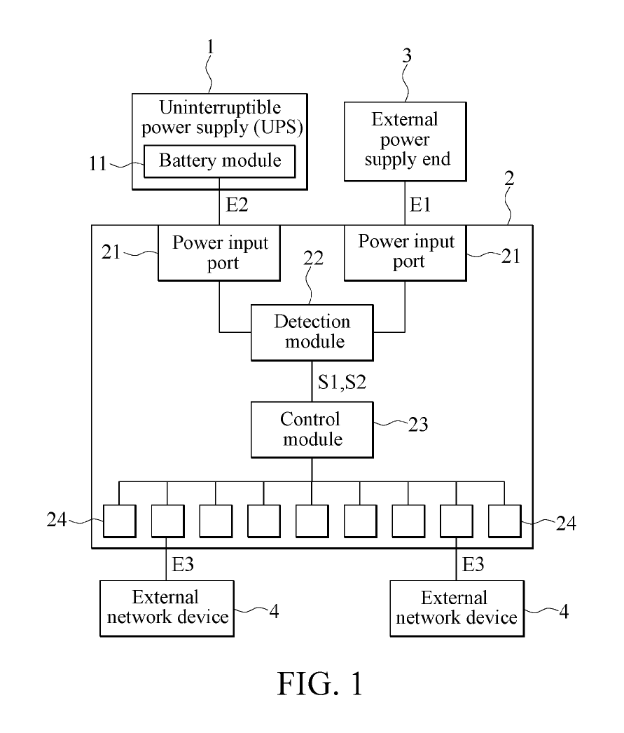

FIG. 1 is a functional block diagram of a network device with an intelligent power configuration function according to an embodiment of the present invention. Referring to FIG. 1, a network device with an intelligent power configuration function 2 includes at least one power input port 21, at least one output port 24, a detection module 22, and a control module 23. The detection module 22 is coupled to the power input port 21, and the control module 23 is coupled to the detection module 22 and the output port 24.

The network device 2 may receive external power by using the power input port 21, so as to work normally. Here, the power input port 21 may be coupled to an external power supply end 3, so as to receive external power E1. In an implementation aspect, the external power supply end 3 may be a mains network and has a mains socket; the power input port 21 may be a power plug; and the network device 2 may be inserted into the mains socket by using the power plug of the power input port 21, so as to receive the external power E1 provided by the mains network. However, the present invention is not limited thereto. In another implementation aspect, the power input port 21 may be a power jack, and may be connected to a mains socket by using an external power line, so as to receive the external power E1 provided by the mains network.

Generally, the network device 2 may be used in combination with a UPS 1. Therefore, when the external power supply end 3 has a failure, such as trip-out or power-off, and is unable to provide the external power E1, the UPS 1 is used instead to provide external power E2 to the network device 2, so as to maintain a normal operation of the network device 2. Here, the UPS 1 includes a battery module 11 that is configured to store power, and output the stored power when the external power supply end 3 has a failure. In other words, the external power E2 is provided by the battery module 11 of the UPS 1.

Besides, the battery module 11 of the UPS 1 may be coupled to the external power supply end 3 and has a charging circuit (not shown in the figure), so that the battery module 11 is charged through the charging circuit by using the external power E1 provided by the external power supply end 3, but the present invention is not limited thereto.

In a connection aspect of the present invention, the network device 2 includes at least two power input ports 21. Two power input ports 21 are used as an example below, but the number thereof is not limited thereto. Here, one power input port 21 may be coupled to the external power supply end 3, so as to receive the external power E1, and the other power input port 21 is coupled to the UPS 1, so as to receive the external power E2 provided by the battery module 11 of the UPS 1 when the external power supply end 3 has a failure and is unable to provide the external power E1.

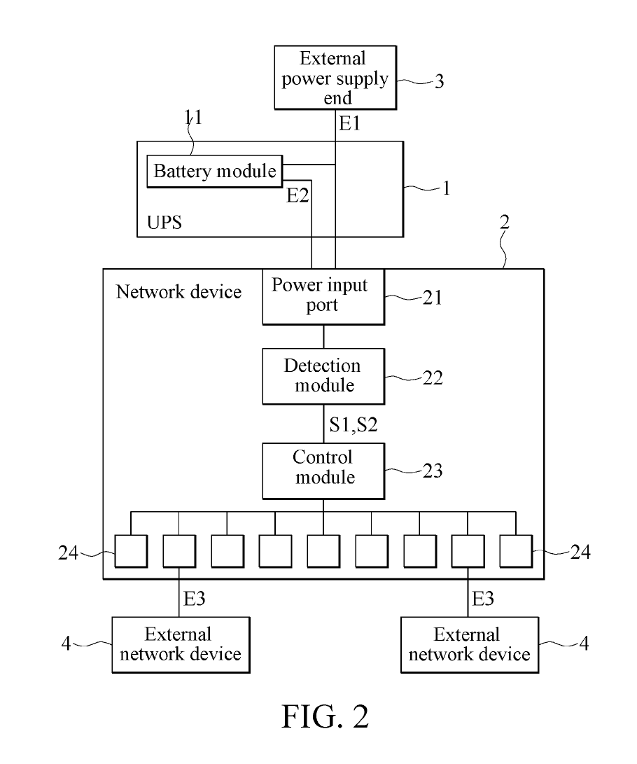

FIG. 2 is a general schematic diagram of another connection aspect between the network device according to FIG. 1, a UPS, and an external power supply end. Referring to FIG. 2, the network device 2 includes at least one power input port 21 that is coupled to the UPS 1, and the UPS 1 is coupled to the external power supply end 3. In other words, in this connection aspect, the power input port 21 is coupled to the external power supply end 3 by using the UPS 1. Besides, the UPS 1 includes a charging circuit (not shown in the figure), so that a battery module 11 may be coupled to the external power supply end 3 by using the charging circuit, so that the battery module 11 is charged by using external power E1 provided by the external power supply end 3.

Therefore, in this connection aspect, the power input port 21 may receive, by using the UPS 1, the external power E1 provided by the external power supply end 3, and when the external power supply end 3 has a failure and is unable to provide the external power E1, the network device 2 receives the external power E2 provided by the battery module 11 of the UPS 1 instead, so as to maintain a normal operation.

An output port 24 of the network device 2 may be connected to an external network device 4, so that the network device 2 performs data transmission with the external network device 4 by using the output port 24. Besides, the output port 24 may further provide, by using the output port 24, the external power E1 (or the external power E2) received by the power input port 21 to the external network device 4 connected to the output port 24, so as to enable the external network device 4 to maintain a normal operation thereof by using external power E3 output by the output port 24.

In an implementation aspect, each output port 24 may be an RJ-45 network socket, and may transmit data and power to an external network device 4 by using a twisted pair such as category 5 cable (CAT-5). A network device 2 may be a network apparatus that may be used as a power supply end, such as a router, a switch, or an optical-to-electrical converter. Besides, the external network device 4 may be a network apparatus that may be used as a power receiving end, such as a network camera or a computer, but the present invention is not limited thereto.

When the network device 2 is unable to obtain the external power E1 from the external power supply end 3, the network device 2 may obtain the external power E2 from the battery module 11 of the UPS 1 instead. At this time, the detection module 22 of the network device 2 may generate an abnormal signal S1 and output same when detecting that the external power received by the power input port 21 is the external power E2 provided by the battery module 11, so as to enable the control module 23 to perform, according to the abnormal signal S1, a corresponding control measure.

In this embodiment, when the control module 23 receives the abnormal signal S1, the control module 23 may sequentially close power output E3 of at least one output port 24 according to a power-off sequence, so as to stop supplying power to an external network device 4 with a relatively low importance hierarchy, and to provide limited power of the battery module 11 to remaining external network devices with relatively high importance hierarchies, thereby prolonging operation times of the external network devices 4 with relatively high importance hierarchies.

Here, each output port 24 of the network device 2 may separately correspond to a power-off priority weight; the power-off priority weight is determined according to an importance hierarchy of an external network device 4 to which the output port 24 is connected; and the power-off sequence is a sequence that is ordered according to values of the power-off priority weights.

In an implementation aspect, the larger a value of a power-off priority weight corresponding to an output port 24 is, the higher a priority of closing power output E3 of the output port 24 is when a control module 23 receives an abnormal signal S1. However, the present invention is not limited thereto. In another implementation aspect, when receiving an abnormal signal S1, a control module 23 preferentially closes power output E3 of an output port 24 corresponding to a power-off priority weight with a minimum value.

Besides, in this embodiment, multiple output ports 24 may correspond to power-off priority weights with equal values due to the same importance hierarchy, and the output ports 24 corresponding to the power-off priority weights with equal values are in a same order in the power-off sequence. In other words, when the control module 23 closes the power output E3 of at least one output port 24 according to the power-off sequence, the control module 23 may simultaneously close the power output E3 of the output ports 24 that correspond to the power-off priority weights with equal values.

Description below is made by using preferentially closing power output E3 of an output port 24 that corresponds to a power-off priority weight with a minimum value as an example, but the example is not intended to limit the present invention.

For example, it is assumed that an external network device 4 connected to an output port 24 of the network device 2 is a network camera used to shoot an important area, such as a network camera used to shoot a door of a bank vault, and a power-off priority weight corresponding to the output port 24 is level ten; and an external network device 4 connected to another output port 24 of the network device 2 is a network camera used to shoot an unimportant area, such as a network camera used to shoot a street outside the bank, and a power-off priority weight corresponding to the output port 24 is level two. Therefore, when the detection module 22 of the network device 2 detects that external power received by the power input port 21 is the external power E2 provided by the battery module 11, the detection module 22 may generate an abnormal signal 21 and outputs same to the control module 23. The control module 23 may preferentially close, according to a power-off sequence, power output E3 of an output port 24 that corresponds to a power-off priority weight with a relatively small value, so as to stop supplying power to the network camera used to shoot the unimportant area, and enable limited power of the battery module 11 to be output through an output port 24 that corresponds to a power-off priority weight with a relatively large value, thereby prolonging an operation time of the network camera used to shoot the important area.

Here, the power-off priority weights corresponding to the output ports 24 are set parameters that may be pre-written, and may be stored in the network device 2. However, the present invention is not limited thereto. Alternatively, the power-off priority weights may be set and adjusted by a user according to importance hierarchies of external network devices to which the output ports 24 intend to be connected. For example, the user may directly set power-off priority weights by using an operation panel or a control button of the network device 2, or may write or adjust values of power-off priority weights corresponding to the output ports 24 by entering, by using a communications agreement such as Telnet, a console application of the network device 2 after communicating with the network device 2 by using an external electronic apparatus such as a computer, a mobile phone, and a tablet computer, so as to change a power-off sequence.

In an implementation aspect of the present invention, after receiving the abnormal signal S1, the control module 23 may not only close the power output E3 of at least one output port 24 according to the power-off sequence, but also determine, according to the current rest capacity of the battery module 11, when to close the power output E3 of the output port 24.

In this embodiment aspect, the control module 23 may sequentially close the power output E3 of the at least one output port 24 according to the power-off sequence each time when the rest capacity of the battery module 11 is reduced by a preset amount. Here, the network device 2 may detect the current rest capacity of the battery module 11 by using the detection module 22, and actuate, each time when it is detected that the rest capacity of the battery module 11 is reduced by a preset amount, the control module 23 to sequentially close the power output E3 of the at least one output port 24 according to the power-off sequence.

For example, it is assumed that the network device 2 includes five output ports 24, power-off priority weights corresponding to the output ports 24 are separately level ten, level eight, level six, level four, and level two, and the preset amount is 20%. After the control module 23 receives the abnormal signal S1, if the current rest capacity of the battery module 11 is 100% and the power is sufficient, the control module 23 may not close power output E3 of any output port 24; when the rest capacity of the battery module 11 is decreased from 100% to 80%, the control module 23 may preferentially close, according to the power-off sequence, power output E3 of an output port 24 that corresponds to the level two power-off priority weight; when the rest capacity of the battery module 11 is decreased to 60%, the control module 23 may further close, according to the power-off sequence, power output E3 of an output port 24 that corresponds to the level four power-off priority weight; when the rest capacity of the battery module 11 is further decreased to 40%, the control module 23 may further close, according to the power-off sequence, power output E3 of an output port 24 that corresponds to the level six power-off priority weight; and the rest can be done in the same manner, so as to prolong operation times of remaining external network devices 4 in a manner of closing the external power one by one, thereby avoiding a situation that all the external network devices 4 are simultaneously stopped.

In another implementation aspect of the present invention, after the control module 23 receives the abnormal signal S1, the control module 23 sequentially closes power output E3 of at least one output port 24 according to a usage time of the battery module 11 and the power-off sequence. The usage time of the battery module 11 refers to a supply time counted from a time when the battery module 11 starts to provide the external power E2.

In this embodiment aspect, the control module 23 may sequentially close the power output E3 of the at least one output port 24 according to the power-off sequence each time when the usage time of the battery module 11 is increased by a preset time. Here, the network device 2 may detect the usage time of the battery module 11 by using the detection module 22, and actuate, each time when it is detected that the usage time of the battery module 11 is increased by a preset time, the control module 23 to sequentially close the power output E3 of the at least one output port 24 according to the power-off sequence.

For example, it is assumed that the network device 2 includes five output ports 24, power-off priority weights corresponding to the output ports 24 are separately level ten, level eight, level four, level four, and level two, and the preset time is 20 min. After the control module 23 receives the abnormal signal S1, if the current usage time of the battery module 11 is 0 min, the control module 23 may not close power output E3 of any output port 24; when the usage time of the battery module 11 achieves 20 min, the control module 23 may preferentially close, according to the power-off sequence, power output E3 of an output port 24 that corresponds to the level two power-off priority weight; when the usage time of the battery module 11 achieves 40 min, the control module 23 may further close, according to the power-off sequence, power output E3 of two output ports 24 that correspond to the level four power-off priority weight; when the usage time of the battery module 11 achieves 60 min, the control module 23 may further close, according to the power-off sequence, power output E3 of an output port 24 that corresponds to the level eight power-off priority weight; and the rest can be done in the same manner, so as to prolong operations times of remaining external network devices 4 in a manner of closing the external power one by one, thereby avoiding a situation that all the external network devices 4 are simultaneously stopped.

In this embodiment, after the control module 23 receives the abnormal signal S1, the detection module 22 keeps detecting whether external power received by the power input port 21 is still provided by the battery module 11. When the detection module 22 detects that the external power received by the power input port 21 is not provided by the battery module 11 any longer and is provided by the external power supply end 3 instead, that is, at this time, the external power supply end 3 is relieved from an abnormal state and may provide the external power E1 to the network device 2 again, the detection module 22 may generate a normal signal S2 and output same, so as to enable the control module 23 to restore, according to the normal signal S2, all the output ports 24 whose power output E3 is closed earlier. In other words, after receiving the normal signal S2, the control module 23 may restart the power output E3 of the output ports 24 that is closed, so as to enable the external network devices 4 to restore normal operations. Besides, after the external power supply end 3 is relieved from the abnormal state, the external power supply end 3 may further provide the external power E1 to the battery module 11 of the UPS 1 again for charging, so as to supplement the power of the battery module 11 that is consumed during a period when the external power supply end 3 has a failure.

To sum up, with the network device with an intelligent power configuration function according to the embodiment of the present invention, when it is detected that received external power is provided by a battery module of a UPS, power supply of an external network device with a relatively low importance hierarchy is stopped first according to a power-off sequence of each output port, so as to prolong operation times of remaining external network devices with relatively high importance hierarchies.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A network device with an intelligent power configuration function, comprising:
at least one power input port, configured to receive external power;
at least one output port, separately configured to be connected to an external network device, and provide the external power received by the at least one power input port to the external network device;
a detection module, configured to generate an abnormal signal when detecting that the external power received by the at least one power input port is provided by a battery module of an uninterruptible power supply (UPS); and
a control module, configured to close, according to a power-off sequence corresponding to each output port, power output of the at least one output port when receiving the abnormal signal, so as to stop supplying power to the external network device.

2. The network device with an intelligent power configuration function according to claim 1, wherein the control module closes the power output of the at least one output port according to the rest capacity of the battery module and the power-off sequence when receiving the abnormal signal.

3. The network device with an intelligent power configuration function according to claim 2, wherein the control module closes the power output of the at least one output port according to the power-off sequence each time when the rest capacity of the battery module is reduced by a preset amount.

4. The network device with an intelligent power configuration function according to claim 1, wherein the control module closes the power output of the at least one output port according to a usage time of the battery module and the power-off sequence when receiving the abnormal signal.

5. The network device with an intelligent power configuration function according to claim 4, wherein the control module closes the power output of the at least one output port according to the power-off sequence each time when the usage time of the battery module is increased by a preset time.

6. The network device with an intelligent power configuration function according to claim 1, wherein the detection module is further configured to generate a normal signal and output same to the control module when detecting that the external power received by the at least one power input port is not provided by the battery module any longer, so as to enable the control module to restore, according to the normal signal, the closed power output of the at least one output port.

7. The network device with an intelligent power configuration function according to claim 1, wherein the at least one power input port is coupled to the battery module of the UPS.

8. The network device with an intelligent power configuration function according to claim 7, wherein one of the at least one power input port is coupled to an external power supply end.

9. The network device with an intelligent power configuration function according to claim 7, wherein the at least one power input port is further coupled to an external power supply end by using the UPS.
